(19) United States
(12) Patent Application Publication
(10) Pub. No.: US 2023/0139108 A1
(43) Pub. Date: May 4, 2023

(54) Device and Method for Safety-Optimized Control of Infotainment Contents

(71) Applicant: Bayerische Motoren Werke Aktiengesellschaft, Muenchen (DE)

(72) Inventors: Boris ISRAEL, Muenchen (DE); Felix LAUBER, Muenchen (DE); Desiree MEYER, Stockdorf (DE); Frederik PLATTEN, Muenchen (DE)

(21) Appl. No.: 17/975,771

(22) Filed: Oct. 28, 2022

(30) Foreign Application Priority Data
Oct. 29, 2021 (DE) 10 2021 128 255.1

(51) Int. Cl. B60W 60/00; B60W 10/18; B60W 10/10; B60W 10/30

(52) U.S. Cl. CPC B60W 60/0015; B60W 10/182; B60W 10/10; B60W 10/30; B60W 2540/10; B60W 2540/12; B60W 2555/60; B60W 2540/229

(57) ABSTRACT

A device and a method for safety-optimized control of infotainment contents in a vehicle are provided. The device includes an ascertainment unit which is configured to register a request to activate nondriving infotainment contents in the vehicle, and to ascertain a basic condition for activating nondriving infotainment contents in the vehicle. The device also includes a control unit which is configured, if a request is registered to activate nondriving infotainment contents in the vehicle and if a basic condition is ascertained by the ascertainment unit, to automatically activate a safety function in the vehicle, wherein the safety function in the vehicle is specifiable for activating nondriving infotainment contents for an operator of the vehicle; and after activating the safety function in the vehicle, to output nondriving infotainment contents for the operator of the vehicle in accordance with the registered request.

### CROSS REFERENCE TO RELATED APPLICATION

This application claims priority under 35 U.S.C. § 119 from German Patent Application No. DE 10 2021 128 255.1, filed Oct. 29, 2021, the entire disclosure of which is herein expressly incorporated by reference.

### BACKGROUND AND SUMMARY

The present invention relates to a device and a method for safety-optimized control of infotainment contents.

Deactivating or blocking specific infotainment contents or infotainment functions in the vehicle for the driver of the vehicle to ensure the traffic safety is known. Thus, for example, if a predetermined travel speed is exceeded or the vehicle is not at a standstill, deactivating nondriving digital contents, e.g., a video streaming service, the display and/or processing of emails, a TV module, etc. as infotainment contents or as infotainment functions in the vehicle for the driver, which can distract the driver from the traffic events, is known. To further increase the level of safety in the vehicle, it can be necessary, for example due to prescribed rules, to introduce safety functions relating to the coupling of the above-mentioned infotainment contents or infotainment functions to the speed of the vehicle. Although the level of safety in road traffic is thus already increased, this has the disadvantage that the driver of the vehicle first has to carry out an action when the vehicle is at a standstill before the infotainment functions or infotainment contents thus deactivated can be reactivated.

The object of the invention is to provide an infotainment solution which increases the level of safety in road traffic and increases the level of comfort for the driver of the vehicle at the same time.

This object is achieved according to the claimed invention.

The above-mentioned object is achieved by a device for safety-optimized control of infotainment contents in the vehicle, comprising:

an ascertainment unit, which is configured:
to register a request to activate nondriving infotainment contents in the vehicle; and
to ascertain a basic condition for activating nondriving infotainment contents in the vehicle; and

a control unit, which is configured, if a request is registered to activate nondriving infotainment contents in the vehicle and if a basic condition is ascertained by the ascertainment unit:
to automatically activate a safety function in the vehicle, wherein the safety function in the vehicle is specifiable for the activation of nondriving infotainment contents for an operator of the vehicle; and
after activation of the safety function in the vehicle, to output nondriving infotainment contents for the operator of the vehicle in accordance with the registered request.

The term vehicle in the context of the document comprises mobile transportation which is used to transport persons (passenger traffic), goods (cargo traffic), or tools (machines or implements). In particular, the term vehicle comprises motor vehicles which are at least partially electrically driven (electric car, hybrid vehicles).

The vehicle can be controlled by an operator or driver of the vehicle. Additionally or alternatively, the vehicle can be a vehicle driving in an at least partially automated manner. The term “automated driving” can be understood in the scope of the document as driving having automated longitudinal or lateral control or automated driving having automated longitudinal and lateral control. Automated driving can involve, for example, driving over a longer time on the freeway or driving for a limited time in the context of parking or maneuvering. The term “automated driving” comprises automated driving with an arbitrary degree of automation. Exemplary degrees of automation are assisted, partially automated, highly automated, or fully automated driving. These degrees of automation were defined by the Bundesanstalt fur StraBenwesen [German Federal Highway Research Institute] (BASt) (see BASt publication “Forschung kompakt [compact research]”, edition November 2012). In assisted driving, the driver continuously executes the longitudinal or lateral control, while the system takes over the respective other function in certain limits. In partially automated driving, the system takes over the longitudinal and lateral control for a certain period of time and/or in specific situations, wherein the driver has to continuously monitor the system as in assisted driving. In highly automated driving, the system takes over the longitudinal and lateral control for a certain period of time without the driver having to continuously monitor the system; however, the driver has to be capable of taking over the vehicle control in a certain time. In fully automated driving (fully autonomous driving mode), the system can automatically manage the driving in all situations for a specific application; a driver is no longer necessary for this application. The above-mentioned four degrees of automation correspond to the SAE levels 1 to 4 of the norm SAE J3016 (SAE—Society of Automotive Engineering). Furthermore, the SAE level 5 is also provided as the highest degree of automation in SAE J3016, which is not included in the definition of the BASt. The SAE level 5 corresponds to driverless driving, in which the system can automatically manage all situations like a human driver during the entire journey.

The vehicle comprises a device for safety-optimized control of infotainment contents in the vehicle.

Infotainment contents in the vehicle comprise in the context of this document digital media contents which can be output in the vehicle by way of a vehicle-side infotainment system. The infotainment system in the vehicle comprises, for example, one or more of the following components: a car radio, an integrated DVD player, a TV module, a navigation system, a microphone, a display unit, for example, display or touch display, a loudspeaker, applications or apps, e.g., a weather app, an app for vehicle operating instructions, a social media app, a video streaming app, etc., which can be installed in the vehicle in the way known from the prior art and can output corresponding digital content via infotainment output units, e.g., a loudspeaker, display units, etc. The infotainment system of the vehicle can additionally or alternatively thereto comprise a communication unit via which mobile terminals, for example, smart phones, smart watches, tablet PCs, personal digital assistants (PDAs), can be coupled to the vehicle for communication in a wireless or wired manner in the way known from the prior art. All content which can be output via the mobile terminal (for example with the aid of applications or apps) can thus also be output via the vehicle-side infotainment system as infotainment contents. Infotainment contents also comprise in the context of this document infotainment functions which are required to retrieve the above-mentioned infotainment contents via the infotainment system, for example, via speech input commands, corresponding inputs via a turn-push controller in the vehicle, which can be coupled to the infotainment system for communication, inputs via corresponding input elements, etc.

The device comprises an ascertainment unit which is configured to register a request to activate nondriving infotainment contents in the vehicle. In other words, the ascertainment unit is configured to register the activation of infotainment functions in the vehicle to output nondriving infotainment contents in the vehicle, for example, as a speech command, via a corresponding input element, via a touchscreen, etc.

The ascertainment unit is moreover configured to ascertain a basic condition for activating nondriving infotainment contents in the vehicle. Nondriving infotainment contents can be deactivated, for example, due to legal and/or traffic safety-relevant rules in the vehicle under specific requirements. For example, the output of a video stream and/or TV content and/or email messages can be deactivated for the driver or operator of the vehicle as long as the vehicle is moving (for example, vehicle speed >0 km/h or vehicle speed >5 km/h). The above-mentioned rules can differ in various regions or countries and can thus be composed arbitrarily. The definition of nondriving digital content can also differ in various regions or countries and can be composed or defined arbitrarily.

The device moreover comprises a control unit. When the ascertainment unit has registered a request for activating nondriving infotainment contents in the vehicle and has ascertained that the basic condition or basic conditions (for example, observing legal rules) are met, the control unit is configured to automatically activate a safety function in the vehicle, wherein the safety function in the vehicle is specifiable for the activation of nondriving infotainment contents for an operator of the vehicle. For example, to increase or ensure the level of safety in road traffic, it can be defined that an output of nondriving digital infotainment contents can only take place if moreover an electric or electromotive parking brake is activated in the vehicle. The safety function can in this case comprise the activation of the electric or electromotive parking brake.

The control unit is moreover configured, after activating the safety function in the vehicle, to output nondriving infotainment contents in the vehicle to the operator or driver of the vehicle at least in accordance with the request to activate nondriving infotainment contents in the vehicle registered by the ascertainment unit.

The level of safety in road traffic is advantageously increased by the activation of the further safety function, wherein the comfort of the driver or operator of the vehicle is ensured at the same time, since no further operating action is required by them to output at least the requested, nondriving digital content.

The ascertainment unit can moreover be configured to register an actuation of the accelerator pedal. This can take place in a manner known from the prior art. When the actuation of the accelerator pedal is registered by the ascertainment unit, the control unit can be configured to deactivate the activated safety function in the vehicle and to deactivate the nondriving infotainment contents for the operator or driver of the vehicle.

As explained above, the basic condition can comprise one or more conditions which comprise, for example, legal rules in a region and/or traffic safety-relevant rules of a region and/or voluntary rules, for example, of the producer of the vehicle to increase the level of safety in road traffic. The basic condition can thus comprise an arbitrary basic condition or an arbitrary combination of conditions to comply with the above-mentioned rules.

For example, the basic condition can comprise one or more of the following conditions which can be ascertained in the manner known from the prior art by the acquisition unit:

ascertained standstill of the vehicle;

ascertained actuation of the brake pedal when vehicle is at a standstill;

ascertained auto hold activation or ascertained activation of the auto hold function in the vehicle. The auto hold function in the vehicle is an assistance system which prevents the avoidable rolling away of the vehicle when at a standstill or when starting, in that it stores the last exerted brake pressure, even if the driver of the vehicle removes the foot from the brake pedal. All wheel brakes remain closed until the driver steps on the accelerator pedal or releases the clutch of the vehicle;

ascertained red traffic signal directly in front of the vehicle. This can be ascertained by at least one suitable sensor unit in the vehicle in the manner known from the prior art;

ascertained standstill of a vehicle driving directly in front of the vehicle. This can be ascertained by at least one suitable sensor unit in the vehicle in the manner known from the prior art; and/or

ascertained standstill of the vehicle immediately after a parking process of the vehicle, wherein the parking process can be, for example, a parking process which was carried out by a parking assistant of the vehicle.

An arbitrary basic condition or a combination of arbitrary basic conditions can therefore advantageously be mapped to ensure the safety in road traffic.

The safety function can comprise any arbitrary vehicle function which is capable of increasing the level of safety in road traffic. For example, the safety function can thus comprise the automatic activation of a parking brake operated in an electric or electromotive manner in the vehicle. Additionally or alternatively thereto, the safety function can comprise the automatic activation or setting of a park setting or parking setting in automatic transmissions.

The level of safety in road traffic is thus advantageously increased, since safety functions, for example, the above-mentioned measures to avoid rolling away of a standing vehicle, are automatically activated.

Nondriving infotainment contents preferably comprise infotainment contents which are capable of distracting the operator of the vehicle from his task of operating the vehicle and/or from traffic events and can comprise one or more of the following infotainment contents:

streaming video content;

displaying emails;

outputting television contents;

outputting digital operating instructions of the vehicle;

etc.

According to a second aspect, the underlying object is achieved by a method for safety-optimized control of infotainment contents in the vehicle, comprising:

registering, by way of an ascertainment unit, a request to activate nondriving infotainment contents;

ascertaining, by way of the ascertainment unit, a basic condition for activating nondriving infotainment contents in the vehicle; and

if a request to activate nondriving infotainment contents in the vehicle is registered and if a basic condition for activating nondriving infotainment contents in the vehicle is ascertained:
automatically activating, by way of a control unit, a safety function in the vehicle, wherein the safety function in the vehicle is specifiable for activating nondriving infotainment contents for an operator of the vehicle; and
after activating the safety function in the vehicle, outputting nondriving infotainment contents to the operator of the vehicle in accordance with the registered request.

The ascertainment unit is preferably moreover configured to register an actuation of the accelerator pedal, wherein the control unit is configured upon registering the actuation of the accelerator pedal:

to deactivate the activated safety function in the vehicle; and

to deactivate the nondriving infotainment contents for the operator of the vehicle.

The basic condition preferably comprises one or more of the following conditions:

ascertained standstill of the vehicle;

ascertained actuation of the brake pedal when vehicle is at a standstill;

ascertained auto hold activation;

ascertained red traffic signal;

ascertained standstill of a vehicle driving directly ahead of the vehicle;

ascertained standstill of the vehicle immediately after a parking process of the vehicle.

The safety function preferably comprises one or more of the following safety functions:

activating the parking brake;

engaging the park setting in the gear selector;

etc.

Preferably, nondriving infotainment contents comprise infotainment contents which are capable of distracting the operator of the vehicle from his task of operating the vehicle and/or from the traffic events and can comprise one or more of the following infotainment contents:

streaming video contents;

displaying emails;

outputting television contents;

outputting digital operating instructions of the vehicle;

etc.

These and other objects, features, and advantages of the present invention will become clear from studying the following detailed description of preferred embodiments and the appended figures. It is obvious that, although embodiments are described separately, individual features therefrom can be combined to form additional embodiments.

### BRIEF DESCRIPTION OF THE DRAWINGS

FIG. 1 schematically shows a device for safety-optimized control of infotainment contents in the vehicle.

FIG. 2 shows an exemplary method for safety-optimized control of infotainment contents in the vehicle.

### DETAILED DESCRIPTION OF THE DRAWINGS

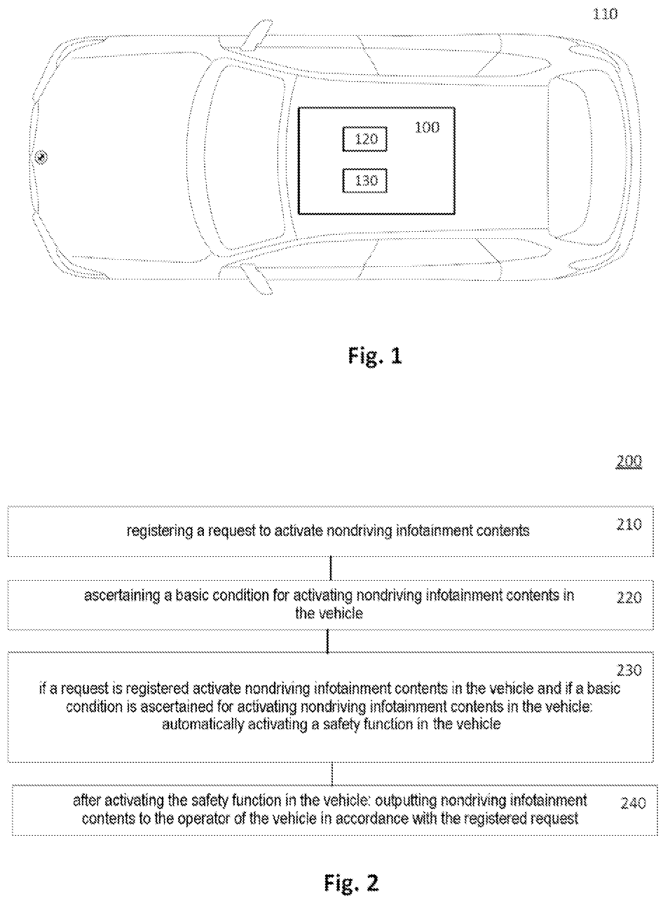

FIG. 1 schematically shows a device 100 for safety-optimized control of infotainment contents in the vehicle 110.

A vehicle 110 comprises a device 100 for safety-optimized control of infotainment contents in the vehicle 110.

Infotainment contents in the vehicle 110 comprise in the context of this document digital media contents which can be output in the vehicle 110 by way of a vehicle-side infotainment system (not shown) known from the prior art. The infotainment system in the vehicle 110 comprises, for example, one or more of the following components: a car radio, an integrated DVD player, a TV module, a navigation system, a microphone, a display unit, for example, display or touch display, a loudspeaker, applications or apps, e.g., a weather app, an app for vehicle operating instructions, a social media app, a video streaming app, etc. which can be installed in the vehicle 110 in the way known from the prior art and can output corresponding digital contents via infotainment output units, e.g., a loudspeaker, display units, etc. The infotainment system of the vehicle 110 can additionally or alternatively thereto comprise a communication unit via which mobile terminals, for example, smart phones, smart watches, tablet PCs, personal digital assistants (PDAs), can be coupled to the vehicle 110 for communication in a wireless or wired manner in the way known from the prior art. All contents which can be output via the mobile terminal (for example with the aid of applications or apps) can thus also be output via the vehicle-side infotainment system as infotainment contents. Infotainment contents also comprise in the context of this document infotainment functions which are required to retrieve the above-mentioned infotainment contents via the infotainment system, for example, via speech input commands, corresponding inputs via a turn-push controller in the vehicle, which can be coupled to the infotainment system for communication, inputs via corresponding input elements, etc.

The device 100 comprises an ascertainment unit 120, which is configured to register a request to activate nondriving infotainment contents in the vehicle 110. In other words, the ascertainment unit 120 is configured to register the activation of infotainment functions in the vehicle 110 to output nondriving infotainment contents in the vehicle 110, for example, as a speech command, via a corresponding input element, via a touchscreen, etc.

Nondriving infotainment contents can comprise infotainment contents which are capable of distracting the operator or driver of the vehicle 110 from his task of operating the vehicle and/or from traffic events and can comprise one or more of the following infotainment contents:

streaming video contents;

displaying emails;

outputting television contents;

outputting digital operating instructions of the vehicle;

etc.

The ascertainment unit 120 is moreover configured to ascertain a basic condition for activating nondriving infotainment contents in the vehicle 110. Nondriving infotainment contents can be deactivated, for example, due to legal and/or traffic safety-relevant rules in the vehicle 110 under specific conditions. For example, the output of a video stream and/or TV content and/or email messages can be deactivated for the driver or operator of the vehicle 110 as long as the vehicle is moving (for example, vehicle speed >0 km/h or vehicle speed >5 km/h) and/or as soon as the vehicle 110 is not in a fully autonomous driving mode. The above-mentioned rules can differ in various regions or countries and can thus be composed arbitrarily. The definition of nondriving digital content can also differ in various regions or countries and can be composed or defined arbitrarily.

As explained above, the basic condition can comprise one or more conditions, which comprise, for example, legal rules in a region and/or traffic safety-relevant rules of a region and/or voluntary rules, for example, of the producer of the vehicle 110 to increase the level of safety in road traffic. The basic condition can thus comprise an arbitrary basic condition or an arbitrary combination of conditions to observe the above-mentioned rules.

For example, the basic condition can comprise one or more of the following conditions which can be ascertained in the manner known from the prior art by the acquisition unit:

ascertained standstill of the vehicle 110;

ascertained actuation of the brake pedal when vehicle is at a standstill;

ascertained auto hold activation or ascertained activation of the auto hold function in the vehicle 110. The auto hold function in the vehicle 110 is an assistance system which prevents the avoidable rolling away of the vehicle 110 when at a standstill or when starting, in that it stores the last exerted brake pressure, even if the driver of the vehicle removes the foot from the brake pedal. All wheel brakes remain closed until the driver steps on the accelerator pedal or releases the clutch of the vehicle 110;

ascertained red traffic signal directly in front of the vehicle 110. This can be ascertained by at least one suitable sensor unit in the vehicle 110 in the manner known from the prior art;

ascertained standstill of a vehicle driving directly in front of the vehicle 110. This can be ascertained by at least one suitable sensor unit in the vehicle 110 in the manner known from the prior art;

ascertained standstill of the vehicle 110 immediately after a parking process of the vehicle, wherein the parking process can be, for example, a parking process which was carried out by a parking assistant of the vehicle 110.

An arbitrary basic condition or a combination of arbitrary basic conditions can thus advantageously be mapped to ensure the safety in road traffic.

The device 100 moreover comprises a control unit 130. If the ascertainment unit 120 has registered a request to activate nondriving infotainment contents in the vehicle 110 and has ascertained that the basic condition or the basic conditions (for example, observing legal rules) are met, the control unit 130 is configured to automatically activate a safety function in the vehicle 110, wherein the safety function in the vehicle 110 for activating nondriving infotainment contents for a driver of the vehicle 110 is specifiable arbitrarily. For example, to increase or ensure the level of safety in road traffic, it can be defined that an output of nondriving digital information contents can only take place if moreover an electric or electromotive parking brake in the vehicle 110 is activated. The safety function can in this case comprise the activation of the electric or electromotive parking brake of the vehicle 110.

The safety function can comprise any arbitrary vehicle function which is capable of increasing the level of safety in road traffic. For example, the safety function can thus comprise the automatic activation of a parking brake operated in an electric or electromotive manner in the vehicle. Additionally or alternatively thereto, the safety function can comprise the automatic activation or setting of a park setting or parking setting in automatic transmissions.

The level of safety in road traffic is thus advantageously increased, since safety functions, for example, the above-mentioned measures for preventing rolling away of a standing vehicle, are automatically activated.

The control unit 130 is moreover configured, after activation of the safety function in the vehicle 110, to output nondriving infotainment contents in the vehicle to the operator or driver of the vehicle at least in accordance with the request registered by the ascertainment unit 120 to activate nondriving infotainment contents in the vehicle 110.

The level of safety in road traffic is advantageously increased by the activation of the further safety function, wherein the comfort of the driver or operator of the vehicle 110 is ensured at the same time, since no further operating action is required by them for the output of at least the requested nondriving digital contents.

The ascertainment unit 120 can moreover be configured to register an actuation of the accelerator pedal. This can take place in a manner known from the prior art. Upon registration of the actuation of the accelerator pedal by the ascertainment unit 120, the control unit 130 can be configured to deactivate the activated safety function in the vehicle 110 and to deactivate the nondriving infotainment contents for the operator or driver of the vehicle 110.

FIG. 2 shows an exemplary method 200 for safety-optimized control of infotainment contents in the vehicle 110, which can be executed by a device 100 as described with reference to FIG. 1.

The method 200 comprises:

registering 210, by way of an ascertainment unit 120, a request to activate nondriving infotainment contents;

ascertaining 220, by way of the ascertainment unit 120, a basic condition for activating nondriving infotainment contents in the vehicle 110; and

if a request to activate nondriving infotainment contents in the vehicle 110 is registered and if a basic condition for activating nondriving infotainment contents in the vehicle 110 is ascertained:
automatically activating 230, by way of a control unit 130, a safety function in the vehicle 110, wherein the safety function in the vehicle is specifiable for activating nondriving infotainment contents for an operator of the vehicle 110; and
after activating the safety function in the vehicle 110: outputting 240 nondriving infotainment contents to the operator of the vehicle 110 in accordance with the registered request.

The ascertainment unit 120 can moreover be configured to register an actuation of the accelerator pedal,

wherein the control unit 130 is configured, upon registering the actuation of the accelerator pedal:

to deactivate the activated safety function in the vehicle; and

to deactivate the nondriving infotainment contents for the operator of the vehicle.

The basic condition can comprise one or more of the following conditions:

ascertained standstill of the vehicle 110;

actuation of the brake pedal when vehicle is at a standstill;

ascertained auto hold activation;

ascertained red traffic signal;

ascertained standstill of a vehicle driving directly ahead of the vehicle 110;

ascertained standstill of the vehicle 110 directly after a parking process of the vehicle 110;

ascertained degree of attentiveness of the operator of the vehicle 110;

ascertained fully autonomous driving mode;

etc.

The safety function can comprise one or more of the following safety functions:

activating the parking brake of the vehicle 110;

engaging the park setting in the gear selector of the vehicle 110;

etc.

Nondriving infotainment contents can comprise infotainment contents which are capable of distracting the operator of the vehicle 110 from his task of operating the vehicle 110 and/or from the traffic events and can comprise one or more of the following infotainment contents:

streaming video contents;

displaying emails;

outputting television contents;

outputting digital operating instructions;

etc.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A device for safety-optimized control of infotainment contents in a vehicle, the device comprising:
an ascertainment unit which is configured:
to register a request to activate nondriving infotainment contents in the vehicle; and
to ascertain a basic condition for activating the nondriving infotainment contents in the vehicle; and
a control unit which is configured, upon registering a request to activate the nondriving infotainment contents in the vehicle and upon ascertaining the basic condition by the ascertainment unit:
to automatically activate a safety function in the vehicle, wherein the safety function in the vehicle is specifiable for activation of the nondriving infotainment contents for an operator of the vehicle; and
after activating the safety function in the vehicle, to output the nondriving infotainment contents for the operator of the vehicle in accordance with the registered request.

2. The device according to claim 1, wherein:
the ascertainment unit is further configured to register an actuation of the accelerator pedal, and
the control unit is further configured, upon registering the actuation of the accelerator pedal:
to deactivate the activated safety function in the vehicle; and
to deactivate the nondriving infotainment contents for the operator of the vehicle.

3. The device according to claim 1, wherein the basic condition comprises at least one of:
ascertained standstill of the vehicle;
actuation of a brake pedal when the vehicle is at the standstill;
ascertained auto hold activation;
ascertained red traffic signal;
ascertained standstill of another vehicle driving directly ahead of the vehicle;
ascertained standstill of the vehicle directly after a parking process of the vehicle;
ascertained degree of attentiveness of the operator of the vehicle; or
ascertained fully autonomous driving mode.

4. The device according to claim 1, wherein the safety function comprises at least one of:
activating a parking brake; or
engaging a park setting in a gear selector.

5. The device according to claim 1, wherein the nondriving infotainment contents comprise infotainment contents which are capable of distracting the operator of the vehicle from a task of operating the vehicle and/or from the traffic events.

6. The device according to claim 5, wherein the infotainment contents comprise at least one of:
streaming video contents;
displaying emails;
outputting television contents; or
outputting digital operating instructions.

7. A method for safety-optimized control of infotainment contents in a vehicle, the method comprising:
registering, by way of an ascertainment unit, a request to activate nondriving infotainment contents;
ascertaining, by way of the ascertainment unit, a basic condition for activating the nondriving infotainment contents in the vehicle; and
upon registering a request to activate the nondriving infotainment contents in the vehicle and upon ascertaining the basic condition for activating the nondriving infotainment contents in the vehicle:
automatically activating, by way of a control unit, a safety function in the vehicle, wherein the safety function in the vehicle is specifiable for activating the nondriving infotainment contents for an operator of the vehicle; and
after activating the safety function in the vehicle, outputting the nondriving infotainment contents to the operator of the vehicle in accordance with the registered request.

8. The method according to claim 7, further comprising:
upon registration of the actuation of an accelerator pedal, by the ascertainment unit:
deactivating, by the control unit, the activated safety function in the vehicle; and
deactivating, by the control unit, the nondriving infotainment contents for the operator of the vehicle.

9. The method according to claim 7, wherein the basic condition comprises at least one of:
ascertained standstill of the vehicle;
actuation of the brake pedal when the vehicle is at the standstill;
ascertained auto hold activation;
ascertained red traffic signal;
ascertained standstill of another vehicle driving directly ahead of the vehicle;
ascertained standstill of the vehicle immediately after a parking process of the vehicle;
ascertained degree of attentiveness of the operator of the vehicle; or
ascertained fully autonomous driving mode.

10. The method according to claim 7, wherein the safety function comprises at least one of:
activating the parking brake; or
engaging the park setting in the gear selector.

11. The method according to claim 7, wherein the nondriving infotainment contents comprise infotainment contents which are capable of distracting the operator of the vehicle from a task of operating the vehicle and/or from traffic events.

12. The method according to claim 11, wherein the nondriving infotainment contents comprise at least one of:
streaming video contents;
displaying emails;
outputting television contents; or
outputting digital operating instructions,
